(19) United States
(12) Patent Application Publication
(10) Pub. No.: US 2023/0171238 A1
(43) Pub. Date: Jun. 1, 2023

(54) Systems and Methods for Using an Identity Agent to Authenticate a User

(71) Applicant: Cisco Technology, Inc., San Jose, CA (US)

(72) Inventors: Oliver Robert Stocker, Ann Arbor, MI (US); Weston Andros Adamson, Ann Arbor, MI (US); James Paul Pringle, Ypsilanti, MI (US)

(21) Appl. No.: 17/456,741

(22) Filed: Nov. 29, 2021

(51) Int. Cl. G06F 21/40

(52) U.S. Cl. CPC H04L 63/0815

(57) ABSTRACT

In one embodiment, a method includes receiving, by an identity agent installed on a device, a credential associated with a user of the device and storing, by the identity agent, the credential on the device. The method also includes capturing, by the identity agent, information associated with a security posture of the device and generating, by the identity agent, an association of the security posture and the credential. The method further includes receiving, by the identity agent, a request for the association of the security posture and the credential from a browser and communicating, by the identity agent, the association of the security posture and the credential to the browser.

### TECHNICAL FIELD

The present disclosure relates generally to communication networks, and more specifically to systems and methods for using an identity agent to authenticate a user.

### BACKGROUND

Authentication is the process of an entity proving its identity to another entity. An individual may gain access to a computer system by identifying and authenticating themselves using a login. Logins are used by computers, applications, and websites to prevent unauthorized access to confidential data. Currently, users have separate logins to unlock their computers and log into their web applications, even when the separate logins are for the same user on the same device. Separate logins create problems such as user friction due to frequent logins and security risks due to each login lacking the context of the other.

### BRIEF DESCRIPTION OF THE DRAWINGS

FIG. 1 illustrates an example system for using an identity agent to authenticate a user;

FIG. 2 illustrates an example flow diagram for using an identity agent to authenticate a user;

FIG. 3 illustrates another example flow diagram for using an identity agent to authenticate a user; and

FIG. 4 illustrates an example computer system that may be used by the systems and methods described herein.

### DESCRIPTION OF EXAMPLE EMBODIMENTS

### Overview

According to an embodiment, a device includes one or more processors and one or more computer-readable non-transitory storage media coupled to the one or more processors and including instructions that, when executed by the one or more processors, cause the device to perform operations. The operations include receiving, by an identity agent installed on the device, a credential associated with a user of the device and storing, by the identity agent, the credential on the device. The method also includes capturing, by the identity agent, information associated with a security posture of the device and generating, by the identity agent, an association of the security posture and the credential. The method further includes receiving, by the identity agent, a request for the association of the security posture and the credential from a first browser and communicating, by the identity agent, the association of the security posture and the credential to the first browser.

According to another embodiment, a method includes receiving, by an identity agent installed on a device, a credential associated with a user of the device and storing, by the identity agent, the credential on the device. The method also includes capturing, by the identity agent, information associated with a security posture of the device and generating, by the identity agent, an association of the security posture and the credential. The method further includes receiving, by the identity agent, a request for the association of the security posture and the credential from a first browser and communicating, by the identity agent, the association of the security posture and the credential to the first browser.

According to yet another embodiment, one or more computer-readable non-transitory storage media embody instructions that, when executed by a processor, cause the processor to perform operations. The operations include receiving, by an identity agent installed on a device, a credential associated with a user of the device and storing, by the identity agent, the credential on the device. The operations also include capturing, by the identity agent, information associated with a security posture of the device and generating, by the identity agent, an association of the security posture and the credential. The operations further include receiving, by the identity agent, a request for the association of the security posture and the credential from a first browser and communicating, by the identity agent, the association of the security posture and the credential to the first browser.

In certain embodiments, the credential indicates that the user is successfully logged into an operating system of the device. The credential may be one of the following: a single sign-on token; a passwordless credential, or a single sign-on credential. In some embodiments, the identity agent receives the credential from a login client installed on the device. In certain embodiments, the identity agent receives the credential from a second browser installed on the device. In some embodiments, the credential is generated by the user or an authentication service. The request may be associated with an application that is federated behind the authentication service.

In certain embodiments, the security posture is associated with one or more of the following: a patch level of one or more operating systems associated with the device; a patch level of one or more applications installed on the device; a presence of one or more security applications associated with the device; and a presence of one or more security controls associated with the device. In some embodiments, the identity agent captures the information associated with the security posture of the device after receiving the request for the association of the security posture and the credential from the first browser.

Technical advantages of certain embodiments of this disclosure may include one or more of the following. Certain systems and methods described herein use an identity agent to authenticate a user. The identity agent allows a user to share their identity across applications on the same device, which may prevent the user from frequently re-authenticating each time the user logs into applications.

Certain embodiments if this disclosure use an identity agent to overcome the limitation of different browsers on a single device not being able to share cookies and other session data that indicate the user has previously logged into the device. Some embodiments of this disclosure may be extended to other applications on a device requesting the user’s identity such as VPN clients or Zero-Trust access applications. Certain embodiments of this disclosure leverage different authentication protocols by allowing them to share the same identity agent, which allows the identity agent to share credentials across several sessions.

In certain embodiments, the identity agent collects information about the security posture of the device, which may provide administrators continuous insight into the security posture of the device accessing applications since this posture may be required to complete the authentication.

Certain embodiments of this disclosure use a login client that acts on behalf of a third-party authentication service/relying party when the user logs into a device, which allows the operating system of the device to authenticate the user on behalf of the third-party authentication service/relying party.

Certain embodiments of this disclosure improve user experience by eliminating password and secrets fatigue while providing unified access to all applications and services. In certain embodiments, security is strengthened by reducing and/or eliminating password management techniques, which may reduce credential theft and/or impersonation. Some embodiments described herein simplify information technology (IT) operations by reducing and/or eliminating the need to issue, secure, rotate, reset, and/or manage passwords.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

This disclosure describes systems and methods for using an identity agent to authenticate a user. In situations where an operating system is already tied into an authentication service, a user can use the same credentials to log into their desktop and subsequent applications. However, the user may be required to authenticate several times in succession as the user accesses applications throughout their day. Certain embodiments of this disclosure use an identity agent to capture the user’s login credential and the device’s security posture information and to use this credential and security posture information to authenticate to subsequent applications the user accesses.

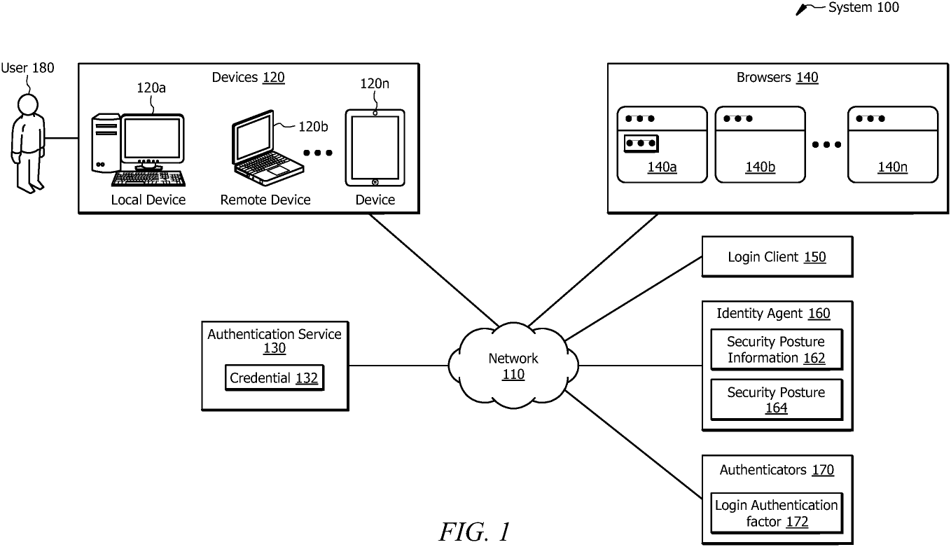

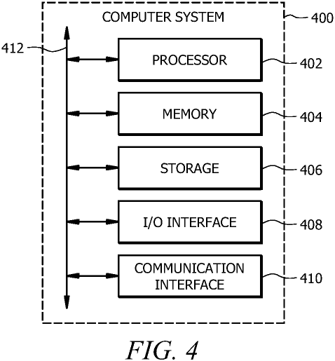

FIG. 1 illustrates an example system 100 for using an identity agent to authenticate a user. System 100 or portions thereof may be associated with an entity, which may include any entity, such as a business, company, or enterprise, that uses an identity agent to authenticate a user. In certain embodiments, the entity may be a service provider that provides authentication and/or security services. The components of system 100 may include any suitable combination of hardware, firmware, and software. For example, the components of system 100 may use one or more elements of the computer system of FIG. 4. In the illustrated embodiment of FIG. 1, system 100 includes a network 110, devices 120, an authentication service 130, browsers 140, a login client 150, an identity agent 160, an authenticator 170, and a user 180.

Network 110 of system 100 is any type of network that facilitates communication between components of system 100. Network 110 may connect one or more components of system 100. One or more portions of network 110 may include an ad-hoc network, the Internet, an intranet, an extranet, a virtual private network (VPN), an Ethernet VPN (EVPN), a local area network (LAN), a wireless LAN (WLAN), a virtual LAN (VLAN), a wide area network (WAN), a wireless WAN (WWAN), an SD-WAN, a metropolitan area network (MAN), a portion of the Public Switched Telephone Network (PSTN), a cellular telephone network, a Digital Subscriber Line (DSL), an Multiprotocol Label Switching (MPLS) network, a 3G/4G/5G network, a Long Term Evolution (LTE) network, a cloud network, a combination of two or more of these, or other suitable types of networks. Network 110 may include one or more different types of networks. Network 110 may be any communications network, such as a private network, a public network, a connection through the Internet, a mobile network, a WI-FI network, etc. Network 110 may include a core network, an access network of a service provider, an Internet service provider (ISP) network, and the like. One or more components of system 100 may communicate over network 110.

Network 110 may include one or more nodes. Nodes are connection points within network 110 that receive, create, store and/or send data along a path. Nodes may include one or more redistribution points that recognize, process, and forward data to other nodes of network 110. Nodes may include virtual and/or physical nodes. For example, nodes may include one or more virtual machines, bare metal servers, and the like. As another example, nodes may include data communications equipment such as computers, routers, servers, printers, workstations, switches, bridges, modems, hubs, and the like. The nodes of network 110 may include one or more devices 120.

Devices 120 of system 100 include any user equipment that can receive, create, process, store, and/or communicate information. Devices 120 may include one or more workstations, desktop computers, laptop computers, mobile phones (e.g., smartphones), tablets, personal digital assistants (PDAs), wearable devices, and the like. In certain embodiments, one or more devices 120 may include a liquid crystal display (LCD), an organic light-emitting diode (OLED) flat screen interface, digital buttons, a digital keyboard, physical buttons, a physical keyboard, one or more touch screen components, a graphical user interface (GUI), and the like. Devices 120 may be located in any suitable locations to receive/communicate information from/to user 180 of system 100.

In the illustrated embodiment of FIG. 1, devices 120 include device 120a through device 120n, where n represents any suitable integer. Devices 120 include local device 120a and remote device 120b. Local device 120a is a physical device that is not attached at some other point on network 110 as a remote device. In certain embodiments, local device 120a may be located on the premises of an employer of user 180. Remote device 120b is a device with remote access. In some embodiments, remote device 120b may be located at a residence of user 180. User 180 may use one or more devices 120 to communicate with authentication service 130.

Authentication service 130 of system 100 is any service that is used to verify a user’s identity. In certain embodiments, authentication service 130 requests information from an authenticating party and validates the information against a configured identity repository using an authentication module. Authentication service 130 may be a program or application installed on device 120. For example, authentication service 130 may include an active directory database locally stored on device 120. Authentication service 130 may include Infrastructure-as-a-Service (IaaS), Platforms-as-a-Service (PaaS), Software-as-a-Service (SaaS), and the like. In certain embodiments, authentication service 130 may provide ondemand availability of computer system resources (e.g., data storage and computing power) without direct active management by user 180. In certain embodiments, the applications user 180 attempts to access on device 120 are federated behind a single authentication service 130 that acts as a relying party to authenticate user 180.

Authentication service 130 may be an active directory service, a federation service, an identity service, an access service, a rights management service, a combination thereof, etc. For example, authentication service 130 may be Microsoft Active Directory, Azure Active Directory, Okta Single Sign-On, Ping Federate, Auth0 Platform, RSA SecurID Access, Duo Security, JumpCloud, IBM Security Verify Access, or any other suitable authentication service. In the illustrated embodiment of FIG. 1, authentication service 130 is an active directory service that provides authentication services to user 180 of device 120.

Browsers 140 of system 100 are application software that may provide access to the World Wide Web. One or more browsers 140 may be used on one or more devices 120 of system 100. For example, one or more browsers 140 may retrieve content from a website’s web server and display the content on one or more devices 120. In certain embodiments, one or more browsers 140 are installed on one or more devices 120. In some embodiments, one or more browsers 140 support one or more authentication protocols. Authentication protocols may include Single-Factor protocols, Two-Factor Authentication (2FA) protocols, Single Sign-On (SSO) protocols, Multi-Factor Authentication (MFA) protocols, Password Authentication Protocol (PAP) protocols, Challenge Handshake Authentication Protocol (CHAP) protocols, Extensible Authentication Protocol (EAP) protocols, Fast identity online (FIDO) protocols (e.g., Universal 2nd Factor (U2F), Universal Authentication Framework (UAF), and/or WebAuthn protocols), and the like.

In the illustrated embodiment of FIG. 1, browsers 140 include browser 140a through browser 140n, where n represents any suitable integer. Browser 140a through browser 140n may include different types of browsers 140 such as Google Chrome, Mozilla Firefox, Edge, Safari, Opera, Konqueror, Lynx, Vivaldi, and the like. For example, browser 140a may be Google Chrome and browser 140b may be Safari. In certain embodiments, user 180 of device 120 uses one or more browsers 140 (e.g., browser 140a) installed on device 120 to log into device 120. For example, user 180 may enter a login authentication factor 172 into an authenticator 170 to log into device 120.

Login authentication factor 172 of system 100 is a security factor that is used to verify the identity and/or authorization of user 180. Login authentication factor 172 may include a personal identification number (PIN), a password, a passphrase, a token (e.g., a hardware token or a software token), a certificate, a smartcard, a biometric (e.g., a fingerprint, a thumbprint, a palm, a handprint), a voice recognition, a facial recognition, a retina scan, an iris scan, a proximity badge, a combination of one or more of the aforementioned, and the like.

Authenticator 170 of system 100 is a cryptographic entity that exists in hardware and/or software. Authenticator 170 may register user 180 with a given authentication service 130/relying party and later assert possession of a registered public key. Authenticator 170 may include a local platform authenticator such as Touch ID or Windows Hello, a roaming authenticator such as a security key (e.g., Universal Serial Bus (USB)), a mobile authenticator (e.g., a mobile application on a smartphone), a dedicated hardware subsystem integrated into device 120, a software component of device 120, and the like.

In certain embodiments, browser 140a prompts user 180 for login authentication factor 172 by communicating with authenticator 170. Browser 140a may capture login authentication factor 172 entered by user 180, which indicates to browser 140a that user 180 has successfully completed their authentication to the operating system of device 120. In some embodiments, browser 140a logs user 180 into the operating system of device 120 using login authentication factor 172. When browser 140a authenticates user 180, browser 140a is acting as a relying party on behalf of authentication service 130.

In certain embodiments, user 180 of device 120 uses login client 150 to log into device 120. Login client 150 of system 100 is an application that authenticates user 180 to device 120. For example, login client 150 of system may authenticate user 180 to an operating system of device 120. In certain embodiments, login client 150 acts as a relying party on behalf of authentication service 130. In some embodiments, login client 150 is installed on device 120 of user 180. Login client 150 may receive, generate, and/or communicate information to one or more components of system 100.

In some embodiments, login client 150 communicates information to authentication service 130. For example, login client 150 may communicate login authentication factor 172 to authentication service 130. In certain embodiments, authentication service 130 uses login authentication factor 172 to identify and unlock credential 132. Credential 132 of system 100 is data that proves the identity and/or qualification of user 180. Credential 132 may be a single sign-on token, a passwordless credential, a single sign-on credential, and the like. Credential 132 may include a private key, a public key, a publicprivate key pair, etc. In certain embodiments, credential 132 is a probabilistically-unique byte sequence that identifies a public key credential source and its authentication assertions. Credential 132 may be generated by user 180 or by authentication service 130. For example, credential 132 such as a username and a password may be supplied by user 180. As another example, credential 132 may be a single sign-on token generated by authentication service 130.

In some embodiments, login client 150 determines credential 132 using login authentication factor 172. For example, login client 150 may use login authentication factor 172 to unlock credential 132. Credential 132 may include some or all of the information included in login authentication factor 172. For example, login authentication factor 172 and credential 132 may be the same value (e.g., the same username and password). Credential 132 may be used to authenticate user 180 to a relying party such as login client 150 across multiple points in an organization. Each credential 132 is unique to a specific login.

In certain embodiments, login client 150 receives credential 132 (which may the same or different value than login authentication factor 172) from authentication service 130 and communicates credential 132 to identity agent 160. Identity agent 160 of system 100 is an application that serves as an intermediary between two applications installed on device 120. In certain embodiments, identity agent 160 securely stores credential 132. For example, identity agent 160 may use one or more encryption methods to securely store credential 132. Since credential 132 received by identity agent 160 from browser 140 and/or login client 150 is unique to that authentication, securely storing credential 132 on device 120 verifies that credential 132 exists only on device 120.

In some embodiments, identity agent 160 identifies and collects security posture information 162 associated with device 120. Security posture information 162 is any information associated with device 120 that provides insight into the attack surface of device 120. Security posture information 162 may include hardware backed keys, hardware or software device IDs, membership in a management system (e.g., Active Directory), device encryption status, a status reported by other software on system 100 (e.g., a status indicating whether anti-virus has detected any threats to device 120), a patch level of one or more operating systems associated with device 120, a patch level of one or more applications installed on device 120, a presence of one or more security applications (e.g., an anti-virus application, a firewall application, etc.) associated with device 120, a presence of one or more security controls (e.g., disk encryption) associated with device 120, and the like. Identity agent 160 generates an association between credential 132 and security posture information 162. In certain embodiments, identity agent 160 generates a security posture 164 of device 120 using security posture information 162.

Security posture 164 represents a level of controls and processes in place to protect device 120 from cyber-attacks. Security posture 164 may be represented as a value, a conceptual diagram, a chart, and the like. For example, security posture 164 may be represented as a value from 1 to 10, wherein a value of 1 indicates that device 120 is not susceptible to cyber-attacks and a value of 10 indicates that device 120 is highly susceptible to cyber-attacks. As another example, security posture 164 may be represented as a conceptual diagram that illustrates potential risk items identified by identity agent 160 such as unpatched software, password issues, phishing, web and ransomware, denial of service attacks, misconfigurations, encryption issues, and the like.

In certain embodiments, identity agent 160 receives a request from browser 140 for authentication information (e.g., credential 132 and/or security posture 164). For example, user 180 may attempt to access a protected resource (e.g., an email account, a human resources system, a task tracking system, etc.) via browser 140 installed on device 120, and browser 140 may reach out to identity agent 160 to verify the identity of user 180. In response to receiving the request for authentication information from browser 140, identity agent 160 may communicate credential 132 and/or security posture information 162 to browser 140. Browser 140 can then share credential 132 and/or security posture information 162 with authentication service 130 to verify the identity of user 180 based on the previous authentication of user 180.

User 180 of system 100 is a person or group of persons who utilize one or more devices 120 of system 100. User 180 may be associated with one or more accounts. User 180 may be a local user, a remote user, an administrator, a customer, a company, a combination thereof, and the like. User 180 may be associated with a username, a password, a user profile, etc.

In operation, login client 150 installed on device 120a (e.g., a desktop computer) prompts user 180 to enter login authentication factor 172 (e.g. a PIN, a mobile application, a biometric, etc.). Login client 150 communicates login authentication factor 172 to authentication service 130. Authentication service 130 identifies credential 132 associated with user 180 using login authentication factor 172 and communicates credential 132 to identity agent 160 installed on device 120. Identity agent 160 securely stores credential 132 on device 120. When user 180 accesses a protected resource in browser 140 installed on device 120, browser 140 communicates a request for credential 132 and security posture 164 to identity agent 160. Identity agent 160 identifies and collects security posture information 162 associated with device 120 and generates security posture 164 using security posture information 164. Identity agent 160 generates an association of credential 132 and security posture 164 and communicates associated credential 132 and security posture 164 to browser 140. Browser 140 then uses credential 132 and security posture 164 to authenticate user 180 to browser 140. As such, browser 140 can authenticate user 180 based on a previous authentication of user 180.

Although FIG. 1 illustrates a particular number of networks 110, devices 120, authentication services 130, browsers 140, login clients 150, identity agents 150, authenticators 170, and users 180, this disclosure contemplates any suitable number of networks 110, devices 120, authentication services 130, browsers 140, login clients 150, identity agents 150, authenticators 170, and users 180. For example, system 100 may include more than one authentication service 130.

Although FIG. 1 illustrates a particular arrangement of network 110, devices 120, authentication service 130, browsers 140, login client 150, identity agent 160, authenticators 170, and user 180, this disclosure contemplates any suitable arrangement of network 110, devices 120, authentication service 130, browsers 140, login client 150, identity agent 160, authenticators 170, and user 180. Furthermore, although FIG. 1 describes and illustrates particular components, devices, or systems carrying out particular actions, this disclosure contemplates any suitable combination of any suitable components, devices, or systems carrying out any suitable actions.

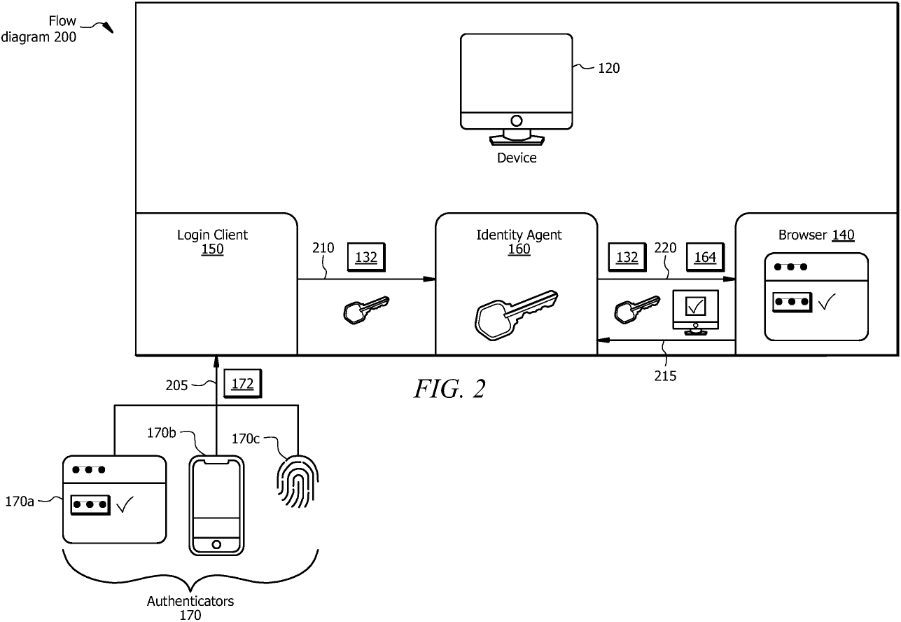

FIG. 2 illustrates an example flow diagram 200 for using an identity agent to authenticate a user. Flow diagram 200 of FIG. 2 may be used by system 100 of FIG. 1 in cases where identity agent 160 receives credential 132 from login client 150. The illustrated embodiment of FIG. 2 includes device 120, browser 140, login client 150, identity agent 160, and authenticators 170. Device 120, browser 140, login client 150, identity agent 160, and authenticators 170 are described in FIG. 1.

At step 205 of flow diagram 200, a user (e.g., user 180 of FIG. 1) of device 120 enters login authentication factor 172 (e.g., a PIN, a biometric, etc.) into authenticator 170. Authenticators 170 include local platform authenticator 170a (e.g., Touch ID or Windows Hello), mobile authenticator 170b (e.g., a smartphone), and biometric authenticator 170c (e.g., a fingerprint scanner). In certain embodiments, login client 150 installed on device 120 prompts the user for login authentication factor 172 by communicating with authenticator 170. Login client 150 captures login authentication factor 172 entered by the user, which indicates to login client 150 that the user has successfully completed their authentication to the operating system of device 120. Login client 150 logs the user into the operating system of device 120 using login authentication factor 172. When login client 150 authenticates the user, login client 150 is acting as a relying party on behalf of the authentication service (e.g., authentication service 130 of FIG. 1) that also protects the subsequent web-based logins. Login client 150 then determines credential 132 (e.g., a passwordless credential, an SSO credential, etc.) using login authentication factor 172. For example, in response to login client 150 communicating login authentication factor 172 to the authentication service, login client 150 may receive credential 132 from the authentication service.

At step 210 of flow diagram 200, login client 150 communicates credential 132 to identity agent 160 installed on device 120. Login client 150 communicates credential 132 to identity agent 160 after login client 150 has successfully authenticated the user. Login client 150 indicates to the operating system of device 120 that login client 150 can log the user into device 120 since the identity of the user has been verified. Upon receiving credential 132 from login client 150, identity agent 160 securely stores credential 132 on device 120. Since credential 132 received from login client 150 is unique to that authentication, securely storing credential 132 on device 120 verifies that credential 132 exists only on device 120.

Identity agent 160 identifies and collects security posture information (e.g., security posture information 162 of FIG. 1) associated with device 120. Security posture information may include a patch level of one or more operating systems associated with device 120, a patch level of one or more applications installed on device 120, a presence of one or more security applications (e.g., an anti-virus application, a firewall application, etc.) associated with device 120, a presence of one or more security controls (e.g., disk encryption) associated with device 120, and the like. Identity agent generates security posture 164 using the security posture information. Identity agent 160 generates an association between credential 132 and security posture 164.

At step 215 of flow diagram 200 a user attempts to access a protected resource (e.g., a work email account) in browser 140 installed on device 120. The protected resource and the authentication service used by login client 150 to authenticate the user are federated. Browser 140 reaches out to identity agent 160 to verify the identity of the user. For example, browser 140 may communicate a request to identity agent 160 for credential 132 associated with the user and security posture information 162 associated with device 120.

At step 220 of flow diagram 200, identity agent 160 communicates credential 132 and security posture 164 to browser 140. Browser 140 can then share credential 132 and security posture 164 with the authentication service. By combining credential 132 with security posture 164, the authentication service can strongly assert and verify that the user logged into device 120 and understand the security posture of device 120 at that point in time.

Although FIG. 2 illustrates a particular number of devices 120, browsers 140, login clients 150, identity agents 160, and authenticators 170, this disclosure contemplates any suitable number of devices 120, browsers 140, login clients 150, and identity agents 160 and authenticators 170. Although FIG. 2 illustrates a particular arrangement of device 120, browser 140, login client 150, identity agent 160, and authenticators 170, this disclosure contemplates any suitable arrangement of device 120, browser 140, login client 150, identity agent 160, and authenticators 170. Furthermore, although FIG. 2 describes and illustrates particular components, devices, or systems carrying out particular actions, this disclosure contemplates any suitable combination of any suitable components, devices, or systems carrying out any suitable actions.

Although this disclosure describes and illustrates particular steps of flow diagram 200 of FIG. 2 as occurring in a particular order, this disclosure contemplates any suitable steps of flow diagram 200 of FIG. 2 occurring in any suitable order. Although this disclosure describes and illustrates an example flow diagram for using an identity agent to authenticate a user including the particular steps of the method of FIG. 2, this disclosure contemplates any suitable flow diagram for using an identity agent to authenticate a user including any suitable steps, which may include all, some, or none of the steps of the method of FIG. 2, where appropriate.

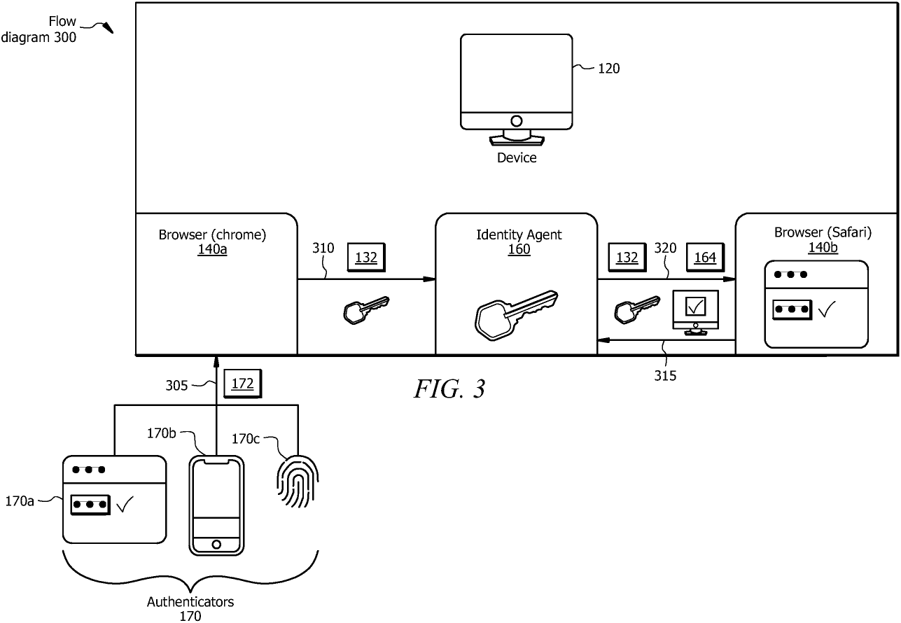

FIG. 3 illustrates another example flow diagram 300 for using an identity agent to authenticate a user. Flow diagram 300 of FIG. 3 may be used by system 100 of FIG. 1 in cases where the identity agent receives a credential from a browser. The illustrated embodiment of FIG. 3 includes device 120, browser 140a, browser 140b, login client 150, identity agent 160, and authenticators 170. Device 120, browser 140a, browser 140b, login client 150, identity agent 160, and authenticators 170 are described in FIG. 1.

At step 305 of flow diagram 300, a user (e.g., user 180 of FIG. 1) of device 120 logs into their account in browser 140a (e.g., Chrome) installed on device 120 using login authentication factor 172 (e.g., a PIN, a mobile application, a biometric). In certain embodiments, browser 140a may prompt the user for login authentication factor 172 by communicating with authenticator 170. Authenticators 170 include local platform authenticator 170a (e.g., Touch ID or Windows Hello), mobile authenticator 170b (e.g., a smartphone), and biometric authenticator 170c (e.g., a fingerprint scanner).

Browser 140a captures login authentication factor 172 entered by the user, which indicates to browser 140a that the user has successfully completed their authentication to device 120. When browser 140a authenticates user 180, browser 140a is acting as a relying party on behalf of the authentication service (e.g., authentication service 130 of FIG. 1) that also protects the subsequent web-based logins. Browser 140a then determines credential 132 (e.g., a passwordless credential, an SSO credential, etc.) using login authentication factor 172. For example, in response to login client 150 communicating login authentication factor 172 to the authentication service, login client 150 may receive credential 132 from the authentication service.

At step 310 of flow diagram 300, browser 140a communicates credential 132 to identity agent 160 installed on device 120 after browser 140a has verified authentication of the user to device 120. In certain embodiments, browser 140a communicates credential 132 to identity agent 160 via a localhost listener once the user has completed authentication in browser 140a. Identity agent 160 can receive credential 132 from browser 140a since the user logged into an authentication service that is aware of identity agent 160. Browser 140a indicates to the operating system of device 120 that browser 140a can log the user into device 120 since the identity of the user has been verified. Upon receiving credential 132 from browser 140a, identity agent 160 securely stores credential 132 on device 120. Since credential 132 received from browser 140a is unique to that authentication, securely storing credential 132 on device 120 verifies that credential 132 exists only on device 120.

Identity agent 160 identifies and collects security posture information (e.g., security posture information 162 of FIG. 1) associated with device 120. Security posture information may include a patch level of one or more operating systems associated with device 120, a patch level of one or more applications installed on device 120, a presence of one or more security applications (e.g., an anti-virus application, a firewall application, etc.) associated with device 120, a presence of one or more security controls (e.g., disk encryption) associated with device 120, and the like. Identity agent generates security posture 164 using the security posture information. Identity agent 160 generates an association between credential 132 and security posture 164.

At step 315 of flow diagram 300, a user attempts to access a protected resource (e.g., a work email application) in browser 140b (e.g., Safari) installed on device 120. The protected resource and the authentication service used by browser 140a to authenticate the user are federated. Browser 140b reaches out to identity agent 160 to verify the identity of the user. For example, browser 140b may communicate a request to identity agent 160 for credential 132 associated with the user and security posture 164 associated with device 120.

At step 320 of flow diagram 300, identity agent 160 communicates credential 132 and security posture 164 to browser 140b. Browser 140b can then share credential 132 and security posture 164 with the authentication service. By combining credential 132 with security posture 164, the authentication service can strongly assert and verify that the user logged into device 120 and understand the security posture of device 120 at that time.

The embodiment illustrated in FIG. 3 overcomes the limitation of different browsers 140 (e.g., browser 140a and browser 140b) on device 120 not being able to share cookies and other session data that may indicate the user has previously logged into device 120. The embodiment of FIG. 3 may be extended to other applications on device 120 requesting the user’s identity, such as VPN client applications, Zero Trust access applications, and the like.

Although FIG. 3 illustrates a particular number of devices 120, browsers 140, identity agents 160, and authenticators 170, this disclosure contemplates any suitable number of devices 120, browsers 140, identity agents 160, and authenticators 170. Although FIG. 3 illustrates a particular arrangement of device 120, browser 140a, browser 140b, identity agent 160, and authenticators 170, this disclosure contemplates any suitable arrangement of device 120, browser 140a, browser 140b, identity agent 160, and authenticators 170. Furthermore, although FIG. 3 describes and illustrates particular components, devices, or systems carrying out particular actions, this disclosure contemplates any suitable combination of any suitable components, devices, or systems carrying out any suitable actions.

Although this disclosure describes and illustrates particular steps of flow diagram 300 of FIG. 3 as occurring in a particular order, this disclosure contemplates any suitable steps of flow diagram 300 of FIG. 3 occurring in any suitable order. Although this disclosure describes and illustrates an example flow diagram for using an identity agent to authenticate a user including the particular steps of the method of FIG. 3, this disclosure contemplates any suitable flow diagram for using an identity agent to authenticate a user including any suitable steps, which may include all, some, or none of the steps of the method of FIG. 2, where appropriate.

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be singleported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or USB drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a LAN, a WAN, a MAN, or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a 3G network, a 4G network, a 5G network, an LTE network, or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A device comprising one or more processors and one or more computer-readable non-transitory storage media coupled to the one or more processors and including instructions that, when executed by the one or more processors, cause the device to perform operations comprising:
receiving, by an identity agent installed on the device, a credential associated with a user of the device;
storing, by the identity agent, the credential on the device;
capturing, by the identity agent, information associated with a security posture of the device;
generating, by the identity agent, an association of the security posture and the credential;
receiving, by the identity agent, a request for the association of the security posture and the credential from a first browser; and
communicating, by the identity agent, the association of the security posture and the credential to the first browser.

2. The device of claim 1, wherein:
the credential indicates that the user is successfully logged into an operating system of the device; and
the credential is one of the following:
a single sign-on token;
a passwordless credential; or
a single sign-on credential.

3. The device of claim 1, wherein the security posture information is associated with one or more of the following:
a patch level of one or more operating systems associated with the device;
a patch level of one or more applications installed on the device;
a presence of one or more security applications associated with the device; and
a presence of one or more security controls associated with the device.

4. The device of claim 1, wherein the identity agent receives the credential from a login client installed on the device.

5. The device of claim 1, wherein the identity agent receives the credential from a second browser installed on the device.

6. The device of claim 1, wherein the identity agent captures the information associated with the security posture of the device after receiving the request for the association of the security posture and the credential from the first browser.

7. The device of claim 1, wherein:
the credential is generated by the user or an authentication service; and
the request is associated with an application that is federated behind the authentication service.

8. A method, comprising:
receiving, by an identity agent installed on a device, a credential associated with a user of the device;
storing, by the identity agent, the credential on the device;
capturing, by the identity agent, information associated with a security posture of the device;
generating, by the identity agent, an association of the security posture and the credential;
receiving, by the identity agent, a request for the association of the security posture and the credential from a first browser; and
communicating, by the identity agent, the association of the security posture and the credential to the first browser.

9. The method of claim 8, wherein:
the credential indicates that the user is successfully logged into an operating system of the device; and
the credential is one of the following:
a single sign-on token;
a passwordless credential; or
a single sign-on credential.

10. The method of claim 8, wherein the security posture is associated with one or more of the following:
a patch level of one or more operating systems associated with the device;
a patch level of one or more applications installed on the device;
a presence of one or more security applications associated with the device; and
a presence of one or more security controls associated with the device.

11. The method of claim 8, wherein the identity agent receives the credential from a login client installed on the device.

12. The method of claim 8, wherein the identity agent receives the credential from a second browser installed on the device.

13. The method of claim 8, wherein the identity agent captures the information associated with the security posture of the device after receiving the request for the association of the security posture and the credential from the first browser.

14. The method of claim 8, wherein:
the credential is generated by the user or an authentication service; and
the request is associated with an application that is federated behind the authentication service.

15. One or more computer-readable non-transitory storage media embodying instructions that, when executed by a processor, cause the processor to perform operations comprising:
receiving, by an identity agent installed on a device, a credential associated with a user of the device;
storing, by the identity agent, the credential on the device;
capturing, by the identity agent, information associated with a security posture of the device;
generating, by the identity agent, an association of the security posture and the credential;
receiving, by the identity agent, a request for the association of the security posture and the credential from a first browser; and
communicating, by the identity agent, the association of the security posture and the credential to the first browser.

16. The one or more computer-readable non-transitory storage media of claim 15, wherein:
the credential indicates that the user is successfully logged into an operating system of the device; and
the credential is one of the following:
a single sign-on token;
a passwordless credential; or
a single sign-on credential.

17. The one or more computer-readable non-transitory storage media of claim 15, wherein the security posture is associated with one or more of the following:
a patch level of one or more operating systems associated with the device;
a patch level of one or more applications installed on the device;
a presence of one or more security applications associated with the device; and
a presence of one or more security controls associated with the device.

18. The one or more computer-readable non-transitory storage media of claim 15, wherein the identity agent receives the credential from a login client installed on the device.

19. The one or more computer-readable non-transitory storage media of claim 15, wherein the identity agent receives the credential from a second browser installed on the device.

20. The one or more computer-readable non-transitory storage media of claim 15, wherein the identity agent captures the information associated with the security posture of the device after receiving the request for the association of the security posture and the credential from the first browser.
